(19) United States
(12) Patent Application Publication
(10) Pub. No.: US 2024/0199479 A1
(43) Pub. Date: Jun. 20, 2024

(54) IMPROVED SOLAR COATING METHOD OF MANUFACTURE AND GLASS LAMINATE COMPRISING SUCH COATING

(71) Applicant: AGP America S.A., Ciudad de Panama (PA)

(72) Inventors: Alexey KRASNOV, Canton, MI (US); Andris SIVARS, Zwijnaarde (BE)

(21) Appl. No.: 18/573,962

(22) PCT Filed: Jun. 29, 2022
(86) PCT No.: PCT/IB2022/056069

§ 371 Date: Dec. 22, 2023

Related U.S. Application Data
(60) Provisional application No. 63/216,496, filed on Jun. 29, 2021.

(51) Int. Cl. C03C 17/36

(52) U.S. Cl. CPC C03C 17/366; C03C 17/3644; C03C 17/3647; C03C 17/3681; C03C 2217/212; C03C 2217/214; C03C 2217/252; C03C 2217/256; C03C 2218/156

(57) ABSTRACT

As the cost of energy has increased, the use of solar coatings on automotive and architectural glazing has enjoyed massive growth. Most solar coatings have metallic silver layers that are highly reflective in the infrared. The silver is deposited over a “wetting” layer which must have a certain level of roughness to prevent agglomeration of the silver and to ensure good adhesion. However, a very smooth wetting layer is beneficial in minimizing haze and improving solar performance. These competing factors make it difficult to deposit a silver layer that promotes both high stability and good adhesion as well as excellent optical and solar properties. The disclosure uses an AgAl/Ag bilayer, which transitions in the composition from silver-aluminum to silver. The bilayer has excellent stability and does not require a rough substrate, thus enabling the use of a smooth high-aluminum-content ZnAlOx wetting layer in providing a coating with superior stability, adhesion, optical, and solar characteristics.

### TECHNICAL FIELD

The disclosure is related to the field of solar-control automotive and architectural glazing.

### BACKGROUND ART

In response to government regulatory requirements for increased energy efficiency as well as the growing public awareness and consumer demand for environmentally friendly products, manufacturers, around the world, have been working to improve the energy efficiency of their products. One of the key areas where major improvements in energy efficiency have been made is solar control. If there is one thing in life that we can count on, it is the fact that the sun will rise each morning bringing with it up to 1,000 watts of radiant energy per square meter. Where this radiant energy is not wanted, it is far more efficient to prevent the entry of the solar energy rather than removing it after the fact.

To that end, highly effective transparent solar-control coatings have been developed for use on both automotive and architectural glazing. The coatings work by acting as a notch filter, i.e., as a mirror in the invisible near infrared range while transmitting a high percentage of visible light. in the 400-700 nm range. The energy from the sun reaching the surface of the earth is comprised of about 3% ultra-violet rays (UV), 55% infra-red radiation (IR) and 42% visible light. Ordinary transparent glass transmits 90-95% in the visible spectrum so it is possible to produce a glazing that only transmits 40% of the total incident solar radiation by using such coatings. By further reducing the visible light transmission, even lower values of total solar energy transmitted can be obtained. Windshields are in the market that while passing over 70% of the visible light only transfer 30-35% of the total solar energy.

When used in an insulated glass unit (IGU), the solar-control coating also functions as a Low Emissivity (Low-E) coating. Low-E coatings further improve upon the insulating effect of an insulated glazing unit by lowering the emissivity of one or more of the interiors facing glass surfaces. Note that the term ‘low-E’ has different meanings in architectural glass and automotive industry. In the latter case, it is commonly referred to a thermal (mid-infrared) reflecting coating on the interior surface of a glazing. Since this surface is not laminated (exposed to the air), traditional so-called ‘soft’ coatings, such as silver (Ag)-inclusive, are not used for low-E. Instead, indium-tin-oxide ‘hard’ coating, insensitive to oxidation and resistant to scratches, is used. In architectural IGUs, on the other hand, the term low-E is widely applied to AG-inclusive coatings deposited on an inner surface of the unit. The exposure to the air is prevented by filling the IGU with an inert gas, most commonly argon.

The early Low-e coatings were relatively simple single layer coatings with relatively simple manufacturing methods. These coatings were very effective in lowering the emissivity and improving the insulating properties of the glass. In cold climates, they helped to reduce the cost of heating a building by reducing heat loss through the windows and by allowing for passive solar heating as they did not block much of the energy in the infrared.

In warmer or hot climates, where the cost to cool a building is greater than the cost to heat, there was little or no value to Low-e windows in a building. To improve the efficiency and expand the market, more complex coatings were developed that had solar-control properties as well as Low-E.

To produce the more complex multilayered coatings, a different technology was needed. Magnetron sputtered vacuum deposition (MSVD), which had primarily been used to applying complex coatings to optical elements and other small objects, was adapted for large scale glass production. In the MSVD process, high energy ions are used to dislodge molecules from a target, which then rain down and are deposited on a substrate, inside of a vacuum chamber. Modern MSVD coating systems can apply complex multiple layer stacks with layer thicknesses typically measured in the nanometer or angstrom range.

The market for MSVD solar-control coated architectural glazing grew rapidly in the 1980s. The first automotive applications began to appear in the early 1990s, but growth was slow as there was relatively little concern of fuel economy. Today, with the automotive market moving towards electrification, the importance of solar-control glazing is increasing as the electrically powered air conditioning unit will directly reduce the range of an all-electric vehicle.

When a thin layer of a metal, such as silver, is applied to a sheet of glass, the result is a mirror-like IR filter with a sharp cut-off at the long-wavelength edge (˜780 nm) of the visible spectrum. By a careful selection of additional layers (optical indexes, and thicknesses), optical filters can be created. Further, multiple metal layers can be applied, one over the other, separated by dielectric and other layers, to further optimize the optical characteristics of the coating.

Solar-control coatings with two, three and even four metal layers are in large scale commercial production for both architectural and automotive use. However, it can be quite challenging to successfully produce complex multilayer nano-scale coatings with high stability, good adhesion, and excellent optical and solar-control performance. Trade-offs and compromises must often be made.

One of the limitations of MSVD coatings is that they are difficult to apply to a substrate that is not flat. If the substrate is curved, the thickness and purity of the layers will not be even and therefore will be degraded. Not only is the performance of the coating compromised, but unacceptable color and other aesthetic issues may occur.

Of course, this is only an issue when the final product is not flat. For automotive applications, where most of the glazing is thermally bent, coatings have been developed that can survive the bending process. These coating are applied to the flat glass prior to bending. On the architectural glazing side, while the glass remains flat in most applications, heat strengthening is often required, and similar heat resistant coating have been developed. One of the challenges with architectural glazing is that some of the glazing may be heat treated and some may not in the same building. It is important that the heat treated and non-heat treated coatings have the same performance and appearance.

On the automotive side, in addition to the issue of bending, there are industry and regulatory requirements for the optical properties of the glazing. The glazing used in the windshield position must comprise laminated safety glass and have visible light transmission of at least 70% in the driver view area.

To accomplish all these objectives, complex multilayer coating stacks have been developed.

While different metals can be used as a functional solar-control element of the coating, metallic silver is the most common. Due to its high conductivity and optical transparency in the visible, silver (Ag) is especially useful when making a coated glazing that enable electrical heated of the windshield. Automotive silver-based coatings are known having a sheet resistance of less than 1 ohm per square which greatly facilitates production of an integral electrical heating circuit. One of the drawbacks of silver is that it is a very active element subject to atomic migration, agglomeration, and dendrite formation when deposited directly on glass or a smooth dielectric even at room temperature. At the elevated glass bending temperature during manufacturing, the silver atoms have a strong tendency to migrate and agglomerate. In severe cases, the agglomerated silver will form dendrites. Migration is a function of time and temperature. Migration of the silver can result in an unacceptable level of haze, degraded solar performance and unacceptable aesthetics due to a change in the reflected and transmitted color.

Methods have been developed to reduce the tendency of silver in coating layers to migrate. The practice of using a rough textured wetting layer under the silver is the most commonly used method.

The stability of individual silver layers is strongly influenced by the material selection of adjacent layers. Typically, a thin layer of oxidized zinc-aluminum (ZnAlOx) is applied as a wetting (also referred to as seeding) layer on top of a dielectric layer with a high index of refraction, such as titanium oxide (TiOx).

Typical levels of aluminum concentration in the ZnAlOx wetting layer range from 1 to 3 percent by weight. The silver layer is deposited over the wetting layer, followed by the deposition of a blocking (or barrier) layer, such as an ultra-thin nickel-chrome (NiCr) layer that almost completely oxidizes to NiCrOx during heat treatment. The role of the wetting layer is to provide proper crystalline properties to the silver. The role of the barrier layer is to encapsulate the delicate silver layer, thus protecting it from the bombardment by damaging high-energetic particles during the high-rate sputtering process of thicker dielectric films. An example of such a coating stack is illustrated in FIG. 2A.

To successfully perform its duty, the wetting ZnAlOx layer must have a certain level of roughness to prevent the silver layer from agglomerating during high-temperature manufacturing steps. The roughness is also beneficial to ensure good adhesion between the layer and adjacent layers of the stack. At the same time, it is highly desirable to have the ZnAlOx with as smooth a surface as possible to minimize haze in the visible spectrum. These competing factors make it difficult to successfully deposit metallic silver over an ZnAlOx wetting layer and get a coating with a high stability, good adhesion, and excellent optical and solar-control performance. The smoothness of the wetting layer increases with the Al content. While a smoother layer would improve the solar properties and reduce haze, the silver will have a greater tendency to migrate. A coating stack with silver deposited over a high aluminum wetting layer is shown in FIG. 2B. This stack will not produce a heat resistant coating. An aluminum content in the 1 to 3% range has commonly been used as the best trade-off between the mentioned conflicting properties.

A coating that does not require such a trade-off would be of high value.

### BRIEF SUMMARY OF THE DISCLOSURE

The present disclosure relates to solar coating which features at least one bilayer as a solar-control functional metal layer. The solar-control coating comprises a top segment of the coating stack, a bottom segment of the coating stack having at least one dielectric layer; and at least one bilayer deposited between the top and bottom coating segment wherein said bilayer is comprised of at least two-layer portions: a top-portion and a bottom-portion; said bilayer is substantially comprised of silver and aluminum, wherein the top-portion is substantially silver and the bottom-portion is substantially silver and aluminum.

At least one of the typical metallic silver layers of the prior art is replaced by a bilayer. The bilayer is deposited starting with the bottom portion comprising a silver-aluminum mixture/alloy with a substantially greater weight percentage (wt %) of silver and then transitioning to a top portion comprising substantially only silver at or before the top of the bilayer.

A small percentage of the aluminum of the bilayer may be partially oxidized to further improve its mechanical and optical properties. The silver and aluminum mixture/alloy portion may start closer to the wetting (e.g., ZnAlOx) layer with the highest percentage of Al in it and may also contain small quantities of impurities, such as Ti, Pt, etc. The top portion of the bilayer, which is pure Ag or silver rich, may also contain small quantities of aluminum and/or other metals.

Typical silver based solar-control coatings have used a thin wetting layer of oxidized zinc-aluminum, with an aluminum concentration in range of between 1 and 3 percent by weight (wt %) deposited over a relatively thick dielectric such as titanium oxide. Surprisingly, the bilayer of the disclosure can make use of a ZnAlOx wetting layer with Al concentration greater than three percent by weight.

The higher aluminum concentration in the wetting layer gives the layer a smoother surface without losing its wetting qualities. This, in turn, improves solar performance while reducing haze after heat treatment. The high aluminum content of the wetting layer promotes its improved bonding to the Ag:Al portion of the bilayer which is beneficial for an improved adhesion as well as forholding the silver atoms in place and preventing their migration and agglomeration. This coating stack is illustrated in FIG. 3B.

In a multi-silver solar-control stack (such as double-, triple-, or quadruple-Ag), at least one of the Ag-inclusive functional layers is a bilayer.

While excellent properties have been obtained with a bilayer deposited over a ZnAlOx wetting layer with a percent aluminum by weight ranging from 4% to 60%, the bilayer has been found to be so effective that the wetting layer can be eliminated, and the bilayer deposited directly over the high-index dielectric, such as TiOx. This approach results in some benefits of optical design but requires additional care in optimizing the TiOx deposition conditions to mitigate the rutile-anatase phase change during the high-temperature bending. The coating stack of this design is presented as an example embodiment of the disclosure and is shown in FIG. 3A. Alternately, the bilayer may be deposited over wetting layers other than ZnAlOx.

The present disclosure also features an automotive glass laminate that comprises at least one glass layer with the solar-control coating as described, which is deposited on an internal surface of the glass laminate.

Finally, the present disclosure also features an MSVD process for deposition of the solar-control coating of the present disclosure, wherein the steps, comprises depositing the bottom segment of the coating stack comprising at least one dielectric layer; depositing at least one bilayer substantially comprised of silver and aluminum placed over at least one dielectric layers; and depositing the top segment of the coating stack.

### Advantages

Superior adhesion.
Low haze.
Resistant to agglomeration.
Resistant to migration.
Resistant to dendrite formation.
Able to withstand higher processing temperatures.
Able to withstand longer bending cycles.
Improved solar properties.
Lower sheet resistance.
Higher visible light transmission.

### BRIEF DESCRIPTION OF THE DRAWINGS

FIG. 1A shows a cross section of a typical laminated automotive glazing.

FIG. 1B shows a cross section of a typical laminated automotive glazing with performance film and coating.

FIG. 1C shows a cross section of a typical tempered monolithic automotive glazing.

FIG. 2A shows a typical solar-control multi-layer coating stack.

FIG. 2B shows a solar-control coating stack with an increased Al concentration in the wetting ZnAlOx layer.

FIG. 3A shows a coating stack with a AgAl/Ag bilayer.

FIG. 3B shows a coating stack with both high-Al ZnAlOx wetting layer and an AgAl/Ag bilayer.

FIG. 4 shows the Zn—Al 2-component phase diagram. (Ref.: Palma et al., “The atmospheric corrosion mechanism of 55% Al—Zn coating on steel,” Corros. Sci., 40 (1998) 61-68.).

FIG. 5 shows an exploded view of a laminated windshield of the present disclosure.

FIG. 6A shows a coating stack with a bilayer comprising a thin aluminum layer followed by a thin silver layer followed by an AgAl layer followed by a metallic silver layer.

FIG. 6B shows a coating stack with a bilayer comprising a thin aluminum layer followed by an AgAl layer followed by a metallic silver layer.

### REFERENCE NUMERALS OF DRAWINGS

2 Glass
4 Plastic Bonding layer (Interlayer)
6 Obscuration/Black Paint
10 Dielectric layer
12 Functional film
14 Wetting/seeding layer
16 Barrier layer
18 Solar-control coating
22 Bilayer
30 Top segment of coating stack
32 Bottom segment of coating stack
101 Exterior side of outer glass layer, number one surface
102 Interior side of outer glass layer, number two surface
103 Exterior side of inner glass layer, number 3 surface
104 Interior side of inner glass layer, number 4 surface
201 Outer glass layer
202 Inner glass layer

### DETAILED DESCRIPTION OF THE DISCLOSURE

The present disclosure can be understood by reference to the detailed descriptions, drawings, examples, and claims, of this disclosure. However, it is to be understood that this disclosure is not limited to the specific compositions, articles, devices, and methods disclosed unless otherwise specified, as such can, of course, vary. It is also to be understood that the terminology used herein is for the purpose of describing aspects only and is not intended to be limiting.

Note that the figures are not drawn to scale. When multiple layers that vary widely in thickness are illustrated, it is not always possible to show the layer thicknesses to scale without losing clarity.

The following terminology is used to describe the laminated glazing of the disclosure.

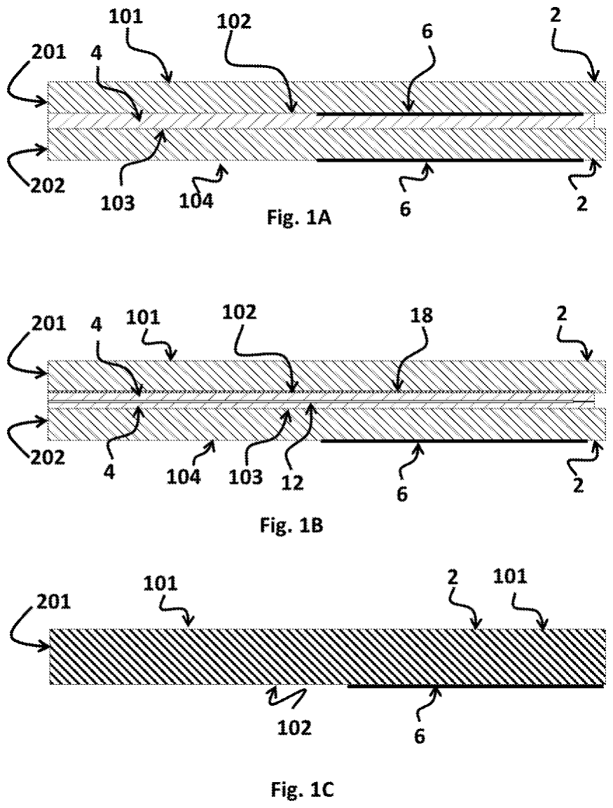

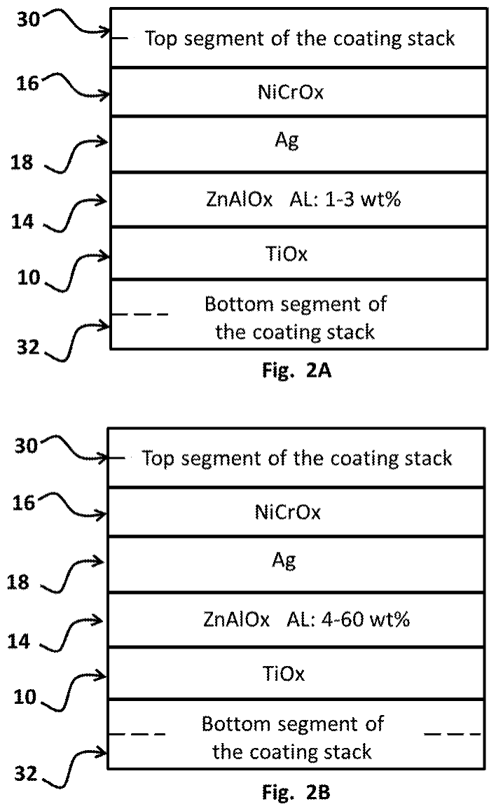

Typical automotive laminated glazing cross sections are illustrated in FIGS. 1A and 1B. A laminate is comprised of two layers of glass, the exterior or outer, 201 and interior or inner, 202 that are permanently bonded together by a plastic bonding layer 4 (interlayer). In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic bonding layer 4. An obscuration 6 may be also applied to the glass. Obscurations are commonly comprised of black enamel frit printed on either the number two 102 or number four surface 104 or on both. The laminate may have a coating 18 on one or more of the surfaces. The laminate may also comprise a functional film 12 laminated between at least two plastic layers 4.

Additional functional coatings can be applied to the inner most surface of the laminate glazing such as on number four surface 104. These functional coatings may include anti-reflective, anti-fingerprint and anti-fog coatings.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle.

An obscuration 6 may be also applied to the glass. Obscurations are commonly comprised of black enamel frit printed on the number two 102 surface. The glazing may have a coating 18 on the number one 101 and/or number two 102 surfaces (not shown).

The term “glass” can be applied to many inorganic materials, including many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids. As the temperature is increased, glass will begin to soften as the glass enters the glass transition range.

Glass is formed by mixing various substances together and then heating to a temperature where they melt and fully dissolve in each other, forming a miscible homogeneous fluid.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions.

Any type of glass may be used as a substrate for the coating of the disclosure. When heated or cooled sufficiently glass undergoes a glass transition. This is different than what happens with most solid materials that are crystalline. When heating and cooling are controlled in a way that kinetics of phase change are allowed, they will undergo a phase change, i.e., the change in state is abrupt and occurs at a precise temperature as the molecules go from moving about freely to being locked in place and vice versa. This is because all the bonds between the molecules are identical and break at the same temperature.

In a glass, due to the random order of the molecules, the bonds are all different. The bond strength is a function of the stress on the bonds and temperature. In a glass, as the material is heated, it reaches a point where the bonds just begin to break, and the glass starts to soften. As the temperature is increased, more of the bonds continue to break and the glass becomes softer until the glass reaches its melting point where the molecules can move more easily. Some say that the glass is in the liquid state, although this might be controversial. This range of temperatures where the glass transitions from a “liquid” to a “solid” is known as the glass transition range. The center of this range is the glass transition temperature (Tg).

There are various processes used to bend the glass layers comprising a laminate. In all processes glass is heated within the glass transition range and then formed to the desired shape by various methods. The temperature is kept to the minimum required as the soft glass can be easily marked by the forming tools. The time required and the temperature depend upon the complexity of the shape and the bending method used. Bending glass with silver based solar coatings can be challenging. The coating reflects the infra-red of the bending oven and can cause high thermal gradients within the glass part. The bigger problem is silver migration. At the elevated temperatures, the silver in the coating will tend to migrate and agglomerate. As a result, there are some glazings requiring higher temperatures and/or longer bending times that cannot be made with a solar-control coating.

A glazing is an article comprised of at least one layer of a transparent material which serves to provide for the transmission of light and/or to provide for viewing of the side opposite to the viewer and which is mounted in an opening in a building, vehicle, wall or roof or other framing member or enclosure.

Laminates, in general, are articles comprised of multiple layers of thin, relative to their length and width, material, with each thin layer having two oppositely disposed major faces, typically of relatively uniform thickness, which are permanently bonded to one and other across at least one major face of each layer. The layers of a laminate may alternately be described as sheets or plies. In addition, the glass layers may also be referred to as panes.

Laminated safety glass is made by bonding two layers of annealed glass together using a plastic bonding layer comprised of a thin sheet of transparent thermoplastic (interlayer).

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer also helps to prevent penetration by objects striking the laminate from the exterior and in the event of a crash occupant retention is improved.

Thermal energy is transferred through glass by means of convective transfer or by being radiated by the glass surface. Emissivity is a measure of how much energy a surface will radiate. Emissivity is quantified as the ratio of heat emitted by an object to that of a perfect black body. The ratio of a perfect black body is 1 while the ratio of a perfect reflector is zero. Standard clear soda-lime glass has an emissivity of 0.84, radiating 84% for the heat absorbed, making it a poor insulator. As a result, windows made of soda-lime glass have poor thermal properties. To improve the thermal properties, coatings have been devised which lower the emissivity of the glass surface. These coatings, known as Low-e, greatly reduce the quantity of thermal radiant heat energy emitted. This energy emitted is a major component of the heat transfer of a window. Reducing the emissivity of the glass surface greatly improves its insulating properties. Low-e coatings are known having an emittance as low as 0.04, emitting only 4% the energy and reflecting 96% of the energy. Many Low-e coatings have the property of reflecting in the infrared on the substrate side of the coating further improving the thermal properties by reducing energy transfer from outside, a desirable characteristic when we are trying to cool the interior. In preferred embodiments, the coating of the present disclosure has an emissivity of less than 0.2%.

Solar-control coatings are generally conductive. For very thin conductive materials we typically characterize the resistance in terms of the sheet resistance. The sheet resistance is the resistance that a rectangle, with perfect bus bar on two opposite sides, would have. Sheet resistance is specified in ohms per square. This is a dimensionally unitless quantity as it is not dependent upon the size of the rectangle. The bus bar to bus bar resistance remains the same regardless of the size of the rectangle.

Full surface windshield heating is commonly provided through the use of a conductive transparent coating. The coating is vacuum sputtered directly onto the glass and is comprised of multiple layers of metal and dielectrics. With resistances in the range of 2-6 ohms per square, a voltage converter is generally needed to reach the power density required. Bus bars are comprised of printed silver frit applied and fired prior to coating or thin flat copper conductors/strips. In preferred embodiments, the solar control coating of the present disclosure has achieved an electrical resistance of less than 1.0 ohm per square.

MSVD coatings for architectural and automotive glazings have been in commercial production for several decades. As such, the many commonly used materials and how their properties vary as a function of the process variables are rather well understood. Many of the patents granted in the field have long since expired and are now in the public domain. As such, many of the coatings currently in production were developed in much that same manner as selecting a recipe from a cookbook.

Most automotive and architectural high-performance solar-control glazing employ a coating recipe having two or more sputtered metallic silver containing nano-scale functional layers embedded into a dielectric stack. The role of each such functional silver containing layer is to enable an adequate reflection of solar radiation in the mid- and near-infrared (IR) as well as the near-ultraviolet (UV) spectral regions, while allowing a high visible transmission. While other metals may be used, silver is preferred for its superior optical, mechanical, electrical, and solar properties. Silver makes and excellent infra-red reflecting mirror.

An additional function of silver-based solar-control coatings in some automotive windshields is to enable de-icing when electric current from a power supply is run through the coating.

From the mechanical standpoint, automotive solar-control laminated windshields must demonstrate a sufficient level of adhesion between individual layers of the coating stack as well as that of the stack itself to the substrate and laminating materials. This is important for safety reasons, i.e., to ensure the integrity of the entire glazing assembly in case of the windshield breakage. Windshields are subject to a series of regulatory requirement tests for penetration and spall which are impossible to pass with poor coating adhesion.

Solar coatings applied to architectural glazing will be mounted in an insulated glass unit frame with the coating on a side internal to the glazing. Automotive glazing with solar-control coatings are generally laminates with the coating on one of the surfaces internal to the laminate (surfaces 2 or 3).

The structure of the disclosure is described in terms of the layers comprising the glazing and the coating. The meaning of “layer,” as used in this context, shall include the common definition of the word: a sheet, quantity, or thickness, of material, typically of some homogeneous substance.

A layer may further be comprised of non-homogeneous material and also of multiple layers as in the case of a multi-layer coatings such as solar coatings. When multiple layers together provide a common function, the multiple layers may be referred to as a layer even if the multiple layers comprising the layer are not adjacent to each other. An example would be a solar protection layer comprising: a solar absorbing glass inner glass layer and a solar reflecting coating applied to the outer glass layer.

The list of coating layers is called the coating stack. When describing a coating stack, we shall use the convention of numbering the coating layers in the order that they are deposited upon the substrate. Also, when discussing two layers, the one closest to the substrate shall be described as below the second layer.

Likewise, the top layer is the very last layer applied and the bottom layer is the very first layer deposited upon the substrate. The top of an individual layer is the side of the layer furthest from the substrate while the bottom is closest to the substrate. When a layer is described as being located in the stack as “over” another layer, the layer may be deposited directly over the other layer or there may be additional layers between the two. Over describes the location of the layer in the stack. The bilayer of the disclosure is always deposited over a thick dielectric. But there may be additional layers deposited between the thick dielectric and the bilayer.

The coating disclosed may be assembled in an infinite combination of layers comprising various material compositions, order and thicknesses that would be impossible to fully enumerate or even adequately generalize. To that end, for the sake of clarity, in the figures and descriptions we shall group the balance of the stack as either the layers immediately above those shown and described as the top segment of the stack 30 and those that are below as the bottom segment of the stack 32. The top and bottom segment may take on any structure and composition desired.

The term metallic is used to describe an object that is substantially comprised of one or more elements classified as metals. A metallic layer may be comprised of a single metal or of a mixture or alloy of more than one metal. A metallic layer may be non-uniform and non-homogeneous. If a single metal is identified, then we can assume that the layer comprises substantially just that metal. A metallic silver layer is assumed to be comprised of substantially just silver. In the same manner, a metallic silver and aluminum layer is assumed to be substantially comprised of just silver and aluminum, but no assumption is made as to the distribution of the two metals.

Haze is a measure of how much light is scattered by a transparent material. It is measured by passing a beam of collimated light through the transparent sample being measured into the interior of a hollow sphere with a reflective coating on the inside walls. The intensity of the light is measured by a photodetector perpendicular to the beam mounted to a side of the sphere. Opposite the entrance of the sphere a light trap is mounted containing a material that absorbs all the light. A reflective shutter can be opened and closed to block the light trap. With the shutter reflecting the light we read the total light transmitted through the glass. With the shutter open and the light being absorbed, we only read the light that is scattered by the sample which is the haze.

Automotive laminates will typically have a haze of less than 2% and preferably as low as possible. Some performance films, interlayers and coatings will increase the haze.

While a vacuum sputtered coating may appear to be perfectly smooth when examining without magnification, the surface of the coating and the individual layers can be quite rough at the nano-scale level. The surface roughness of the layers has a significant impact on optical performance, in particular their solar load reduction properties. The ideal is to reflect all the energy in the desired frequency band back to the environment blocking it from passing through the glazing. In practice, some of the energy is absorbed by the transparency as the beam passes through the glass on its way to the coating and a second time as it is reflected and exits the transparency. Any scattering caused by the surface roughness will tend to increase the energy absorbed as the light will likely take a longer path or become trapped within the two outer surfaces of the glazing by total internal reflection. The unwanted reflections also reduce the amount of visible light transmitted through the substrate.

The surface roughness increases haze which is undesirable from an optical and aesthetic point of view. Haze in excess of 2% can become very noticeable under some lighting conditions. Besides compromising aesthetics, haze also reduces the visible light transmission. If regulatory requirement for visible light transmission cannot be met because of haze, then the metallic layers must be made thinner to compensate.

The perfect coating would have layers that are all very smooth at the nano-level. However, the various layers are essentially built up like a brick wall with no mortar. For the most part, the layers do not chemically bond. We need a certain amount of roughness in order to facilitate a good bond between most of the layers. Even nano-scale structures are subject to stress. A coating with excellent solar performance and low haze might have poor adhesion. Likewise, a coating with excellent adhesion might have poor solar properties and high haze.

The solar-control performance of individual silver layers is strongly influenced by the material selected for the adjacent layers. To deposit pure metallic silver over a dielectric layer, we need to first apply a thin wetting (seeding) layer to facilitate the deposition of the silver ions. The role of the wetting layer is to provide proper crystalline properties to the silver.

Typically, a thin layer of oxidized zinc-aluminum (ZnAlOx) is applied as a wetting (or seeding) layer. This wetting layer is deposited over the top of a dielectric layer with a high index of refraction, such as titanium oxide (TiOx). Historically, typical levels of Al concentration in the ZnAlOx wetting layer have ranged between 1 and 3 wt. %. The silver layer is deposited on top of the wetting layer, followed by the deposition of a barrier layer, such as an ultra-thin nickel-chrome (NiCr) layer that almost completely oxidizes to NiCrOx during heat treatment. The role of the barrier layer is to encapsulate the delicate silver layer, thus protecting it from the deposition bombardment by damaging high-energetic particles during the sputtering process.

As discussed, metallic silver is a very active element. Even at room temperature silver is prone to migration especially in the presence of an electrical field. At the elevated glass bending temperature, the silver layer has a strong tendency to migrate and agglomerate. In severe cases, the silver will form dendrites noticeable to the eye. Therefore, the wetting ZnAlOx layer must have a certain level of roughness due to its crystallinity to prevent the Ag layer from agglomerating during high-temperature manufacturing steps. The roughness is also beneficial to ensure good adhesion between the layer and the adjacent layers of the stack. At the same time, it is highly desirable to have the ZnAlOx with a smooth surface to minimize haze in the visible spectrum. These competing factors make it difficult to successfully deposit an Ag layer with a high stability, good adhesion, and excellent optical and solar-control performance.

This ZnAlOx wetting layer, with an aluminum content between one to three percent by weight, is one of the standard ingredients common to many of the solar-control coating recipes. This range has been used as a standard practice for many years with the view of providing a level of surface roughness enabling the best tradeoff between haze and adhesion. While this range does function adequately it is still a trade-off. Modern developments in automotive glazing design, especially the tendency for more aggressive shapes, push the technological envelope beyond the current limits. For instance, there are glazing shapes under development that require bending temperatures higher than currently used (about 630 degrees C.). Such increased temperatures and/or longer bending cycles require new and improved approaches in the design of solar-control functional layers and, particularly, the interface between the Ag and wetting layers.

During the development of the present disclosure, the surprising discovery was made that the tradeoff between the above-mentioned competing qualities of the wetting layer could successfully be balanced by increasing the weight percentage of aluminum in the ZnAlOx. Depending on the type of the sputtering target used in the manufacturing process, this can be done by adding more aluminum to metallic (ZnAl) or ceramic (ZnAlOx) targets.

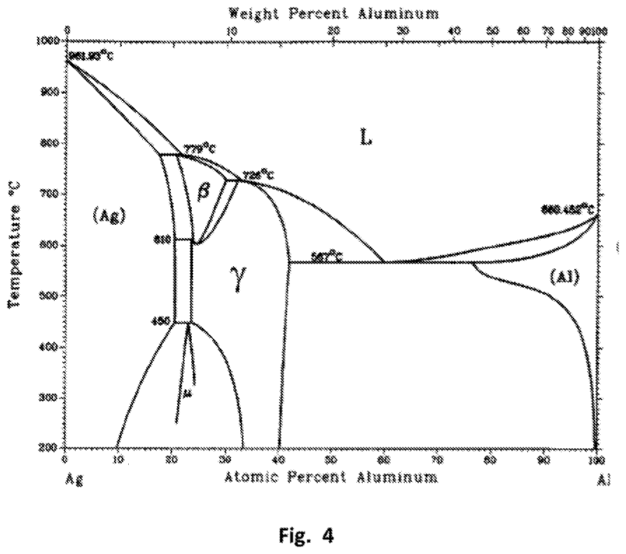

The aluminum concentration in the ZnAlOx layer of the current disclosure is between 4 and 60 percent by weight. This high of a level of aluminum is not found in prior art as a wetting layer for silver-inclusive solar-control coatings. It is important for the ZnAl target preparation that Zn and Al can alloy in a wide concentration range as shown in the ZnAl phase diagram of FIG. 4. It is important to note that the ZnOx portion of the resultant ZnAlOx provides the desired crystallinity of the wetting layer while the AlOx promotes the layer smoothness and an improved adhesion to the Ag or the AgAl/Ag bilayer.

A clear benefit of adding more aluminum to the wetting ultra-thin layer is that it widens the process window for balancing the mechanical, crystallographic, and optical properties of the Ag/ZnAlOx layer combination. Yet, it does not completely solve the problem of the tradeoff between the competing factors controlling the haze, the mobility of the silver molecules during heat treatment, and the visible and IR reflection.

As the aluminum content increases the surface of the layer becomes smoother, reducing haze and increasing solar performance. The adhesion would be reduced for a traditional ZnAlOx/Ag combination but not for a combination of the ZnAlOx and the Ag/AgAl bilayer of the present disclosure.

It is worth mentioning that of a particular vulnerability, is the bottommost silver-inclusive functional layer, the one closest to the glass substrate on which the entire layer stack is deposited. One of the reasons for this part of the stack to be the weakest point is the accumulated stress applied by the top segment of the stack and the fact the any agglomeration of the silver inevitably leads to weakening of the bond to the blocking barrier (NiCrOx) layer above the silver. In this regard, at least one Ag/AgAl, IR-reflective bilayer is used to ensure its smoothness and anti-agglomeration properties during high-temperature treatment steps. This can be done, e.g., by depositing the bottom half from a AgAl sputtering target(s) and the top half from a pure Ag target or a Ag target containing a small percentage of impurities. These two types of targets can be in the same or adjacent compartments of the coater. The concentration of Al in the bottom AgAl half is disclosed to range from 1 to 20 percent by weight more preferably from 2 to 10 percent by weight yet more preferably from 4 to 6 percent by weight.

The disclosure is not limited to the material choice of ZnAlOx for the wetting layer. Other thin transparent conductive oxides can alternatively be used, such as ZnSnOx, InGaZnOx, InZnOx, etc.

We can speculate on why these configurations produce their surprising results based upon the material properties of aluminum and silver. While the two metals are very similar in many of their mechanical properties (Young's modulus, Poison's ratio, shear modulus, ductility, hardness), aluminum has one quarter of the density of silver. At the atomic level, a layer of pure aluminum will be much smoother than one of comparable thickness comprising only silver. This may be why conventional wisdom held that the level of aluminum in the ZnAlOx layer should be in the 1% to 3% range. In fact, increasing the aluminum percent by weight in excess of this range results in a smoother surface and a greater tendency of the silver layer to migrate and agglomerate during heating. However, by initially depositing over the ZnAlOx layer a mixture of aluminum and silver before transitioning to just silver in the bilayer, the aluminum of the bilayer forms a strong bond to the aluminum in the ZnAlOx layer while also anchoring the mixed and subsequently deposited silver. Thus, we can achieve a very smooth silver layer with low haze that is also resistant to the migration that we would normally get with a high aluminum content, in excess of three percent by weight, in the wetting layer. In fact, the stability of the aluminum/silver bilayer is so good that it can be used with other wetting layer compositions or even applied directly over the dielectric layer. We can further speculate that some of the attributes where the two metals (Ag and Al) are also far apart play a role. These include the thermal conductivity, specific heat, the melting point, latent heat of fusion and fracture toughness.

By analogy we can compare this deposition process to laying a paver patio. A wetting layer with three percent by weight aluminum in analogous to a pea gravel base with three percent by weight fine sand versus a base with 4-60% sand. Of course, the base with the higher sand content will be smoother. Now, consider pavers with a smooth enameled finish versus ordinary fired pavers with a rough finish. The rough finish will tend to stay in place and not shift. This is analogous to the bilayer in which the silver-aluminum initial portion is more stable and forms a strong bond to the wetting layer.

When designing a heated windshield to be used with a conventional 12-volt electrical system, one of the biggest challenges is to produce a design that can operate without the benefit of a voltage converter. The typical solar coating with 2 or even 3 silver layers has a sheet resistance in the range of 1-5 ohms per square. For most vehicles, the bus bars need to be too far apart to have a low enough resistance to generate enough heat and effectively clear snow and ice from the windshield. Additional layers of silver can be deposited but this will increase the haze while decreasing visible light transmission. The lower limit for visible light transmission through a windshield is 70%. It is difficult to keep the visible light transmission about 70% with double and triple silver coatings. With four silver layers, we need to make the individual layers even thinner and deposit more dielectric, wetting and barrier layers for each of the additional silver layers which increases the changes of producing optical defect. The coating of the disclosure can be used to develop coatings with visible light transmission that is greater than 70% and a sheet resistance of under 0.8 ohms per square due to the improved and lower haze and superior optical properties. Even lower sheet resistances are possible. Further, the sheet resistance, within a limited range, can be tuned by means of the introduction of aluminum oxide in the bilayer.

Another advantage of the coating is that it can be applied to and processed on parts that formerly could not be produced with a complex silver base coating. This is due to the coating's resistance to agglomeration. The coating can survive higher temperatures and longer duration glass bending cycles.

Another benefit is the fact that the modified coating of disclosure can be applied using the same type of coater that can produce a typical metallic silver-based coating by just changing the targets and process parameters.

The present disclosure can be used in solar-control windshields, heatable windshields, architectural glazing, and other applications that might use solar-control coatings.

Some embodiments comprise a single metal bilayer divided into a silver top half and a silver-aluminum bottom half. This 1:1 top to bottom ratio was selected to optimize throughput and manufacturability in large-area high speed glass coaters. This is not to be construed as a limitation. If the bilayer has silver on the top and AgAl on the bottom, substantially any ratio may be used to the same effect.

An extreme of the AgAl-to-pure Ag ratio would be an ultra-thin Al or AlOx from a sub-monolayer to a few-monolayer thick, deposited on the bottom TiOx or another bottom dielectric with or without the wetting layer. Note from the AgAl phase diagram that only the mixtures with Al weight percentage close to 100% are practical since their melting point is around 660 degrees C., with bending temperatures of the coated automotive glass in the range of 630 C. To optimize throughput and manufacturability in large-area high speed glass coaters. This is not to be construed as a limitation. The AlAg/Ag bilayer of the disclosure has been found to be effective with other common wetting layer compositions. It also works well with no wetting layer when deposited directly over the thick dielectric. The total thickness of the bilayer is dependent upon the materials selected for the rest of the coating stack as well as the desired properties and function of the coating. In an automotive solar-control application, where visible light transmission must be at least 70% while solar performance is maximized though the use of multiple metallic layers, a single bilayer with a thickness in the range of 5 nm to 40 nm has been found to be effective. This is not to be construed as a limitation. A bilayer that is outside of this range may also be just as effective depending upon the coating stack and application.

When the AgAl bilayer is deposited directly over the TiOx, a TiAlAg (a variant of the gamma-TiAl alloy) forms under the influence of energetic particles during sputtering; this is a well-known, thermally and chemically stable alloy used, for instance, in aviation and aerospace.

The bilayer may also comprise some percentage of aluminum oxide to further enhance adhesion as well as to alter the electrical properties of the coating.

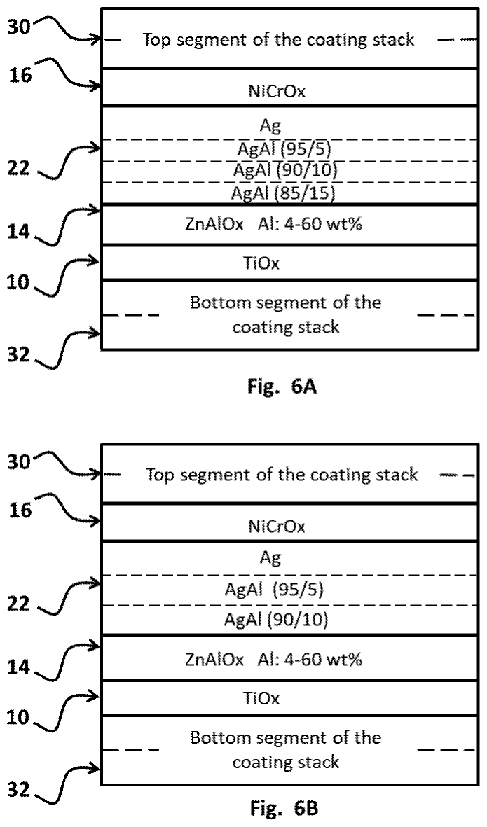

We note that while bilayer implies the presence of two distinct layers, in fact the description is more intended to reflect the two different material compositions through the thickness of the bilayer. The silver portion of the bilayer may be divided into more than one layer of the thickness. In the same manner the silver/aluminum layer may also comprise more than one composition (e.g., to be graded). Each of the two layers is comprised substantially of the said material: the silver layer is substantially silver, and the silver/aluminum layer is substantially silver and aluminum and in any ratio. Small quantities of other compounds and elements may be included without departing from the bilayer of the disclosure. As an example, we may first deposit a monolayer of 90/10 silver/aluminum mix, followed by a 95/5 silver/aluminum mix with a thickness equal to half of the total bilayer thickness followed by a pure silver or a silver layer comprising 99.9% silver and 0.1% of a dopant or impurity element such as Pt. An example of a bilayer comprising four distinct layers is show in FIG. 6A. An example of a bilayer comprising three distinct layers is show in FIG. 6B.

### EXAMPLES

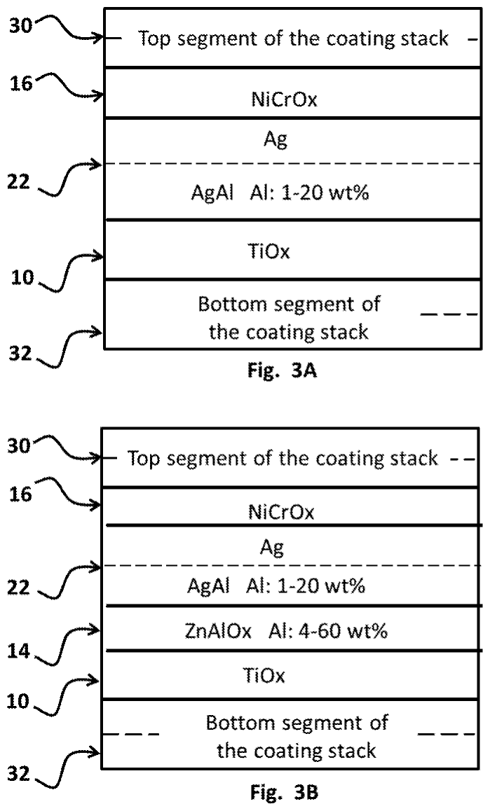

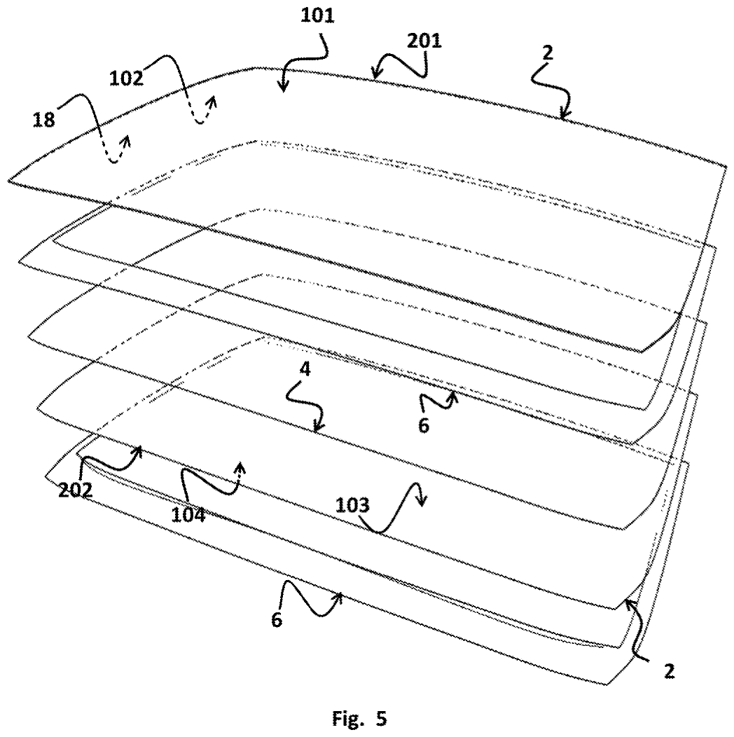

Example one: is a large, laminated windshield, shown in FIG. 5, having a maximum width of 1200 mm and a centerline height of 800 mm. The outer glass layer 202 is 2.4 mm thick ultra-clear soda lime glass. The number two surface 102 of the outer glass layer 201 has a solar-control coating 18 applied to it prior to bending. The inner glass layer 202 is 1.8 mm thick solar green soda-lime glass. A black frit obscuration 6 is screen printed on surfaces two 102 and on surface four 104. The two glass layers are joined by means of an 0.76 mm thick layer of PVB interlayer 4. The coating has a Ag/AgAl bilayer 22 deposited over a ZnAlOx wetting layer 14 comprising 20% aluminum by weight similar to what is depicted in FIG. 3B. The bottom half of the bilayer is comprised of 80 wt % of silver and 20 wt % of aluminum. The top half of the bilayer is pure silver. The bilayer 22 is the first metal layer in the three-Ag inclusive layer stack. A NiCrOx barrier layer 16 is deposited over the bilayer. The top segment of the coating stack 30 includes three additional metal layers which are pure metallic silver. These additional metal layers are not shown in the FIG. 3B.

Example two: is the same as Example one with the exception that the coating bilayer being deposited directly over the TiOx dielectric layer.

Example three: is the same as Example one with the exception of the coating. The thickness ratio of the AlAg to Ag in the bilayer is 1:2.

Example four: is the same as Example one with the exception of the coating. The thickness ratio of the AlAg to Ag in the bilayer is 1:3.

Example five: is the same as Example one with the exception of the coating. The thickness ratio of the AlAg to Ag in the bilayer is 1:4.

Example six: is the same as Example one with the exception of the wetting layer. The ZnAlOx comprises 4% aluminum by weight.

Example seven: is the same as Example one with the exception of the wetting layer. The ZnAlOx comprises 8% aluminum by weight.

Example eight: is the same as Example one with the exception of the wetting layer. The ZnAlOx comprises 12% aluminum by weight.

Example nine: is the same as Example one with the exception of the wetting layer. The ZnAlOx comprises 15% aluminum by weight.

Example ten: is the same as Example one with the exception of the coating. The bilayer is comprised as illustrated in FIG. 6A. The aluminum content in ZnAlOx is 5%.

Example eleven: is the same as Example one with the exception of the coating. The bilayer is comprised as illustrated in FIG. 6B. The aluminum content in ZnAlOx is 5%.

Example twelve: is the same as Example one with the exception of the coating. The coating is deposited on the number three surface 103 of the inner glass layer 202.

Example thirteen: is the same as Example one with the addition of a functional coating deposited on the number four surface 104 of the inner glass layer 202. The functional coating can be selected from the group consisting of anti-reflective, anti-fingerprint and anti-fog.

It must be understood that the present disclosure is not limited to the examples and embodiments described and illustrated, as it will be obvious for an expert on the art, there are different variations and possible modifications that do not strive away from the disclosure's essence, which is only defined by the following claims.

1. A solar-control coating, comprising:
a top segment of the coating stack;
a bottom segment of the coating stack having at least one dielectric layer; and
at least one bilayer deposited between the top and bottom coating segment wherein:
said bilayer is comprised of at least two-layer portions: a top-portion and a bottom-portion;
said bilayer is substantially comprised of silver and aluminum, wherein:
the top-portion is substantially silver; and
the bottom-portion is substantially silver and aluminum.

2. The solar-control coating of claim 1, wherein the thickness of the bilayer is between 5 nm and 30 nm.

3. The solar-control coating of any of the preceding claims, wherein the bilayer is the first metal layer of the coating stack when counting from the substrate on which it is deposited.

4. The solar-control coating of any of the preceding claims, wherein the bilayer is at least partially comprised of aluminum oxide.

5. The solar-control coating of claim 1, wherein the bilayer ratio of the aluminum-silver portion to the silver portion by thickness is at least 1:1, or 1:2, or 1:3.

6. The solar-control coating of claim 1, wherein the bilayer ratio of the aluminum and silver portion to the silver portion by thickness is less than or equal to 1:3.

7. The solar-control coating of claim 1, wherein the aluminum-silver portion of the bilayer is comprised of 1 to 20% by weight aluminum, or preferably of 2 to 10% by weight aluminum.

8. The solar-control coating of claim 1, wherein the aluminum-silver portion of the bilayer is comprised of 4 to 6% by weight aluminum, or of 95 to 99% by weight aluminum.

9. The solar-control coating of any one of the preceding claims, wherein said at least one dielectric layer is comprised of TiOx.

10. The solar-control coating of any one of the preceding claims, further comprising a wetting layer deposited between the bottom segment of the coating stack and the bilayer.

11. The solar-control coating of claim 10, wherein the wetting layer is selected from the group consisting of ZnAlOx, ZnSnOx, InGaZnOx, or InZnOx, or preferably a wetting layer of ZnAlOx comprised of aluminum in the range of 4 to 60% by weight.

12. The solar-control coating of any one of the preceding claims, further comprising at least one metallic silver layer.

13. The solar-control coating of any one of the preceding claims, wherein such coating is deposited over a glass layer.

14. An automotive glass laminate, comprising at least one glass layer with the solar-control coating of any one of claims 1 to 13 deposited on an internal surface of the glass laminate.

15. The automotive glass laminate of claim 14, further comprising a functional coating on the surface facing the interior of a vehicle selected from the group consisting of anti-reflective, anti-fingerprint, and anti-fog.

16. The automotive glass laminate of any one of claims 14 to 15, wherein said automotive glass laminate is a heatable windshield.

17. An MSVD process for deposition of the solar-control coating of claim 1, wherein the process comprises the steps of:
depositing the bottom segment of the coating stack comprising at least one dielectric layer;
depositing at least one bilayer substantially comprised of silver and aluminum placed over at least one dielectric layers; and
depositing the top segment of the coating stack.

18. The process of claim 17, further comprising the step of depositing a wetting layer between the bottom segment of the coating stack and said bilayer, wherein said wetting layer consists of ZnAlOx and comprises 4 to 60% aluminum by weight.
